(19) United States
(12) Patent Application Publication
(10) Pub. No.: US 2015/0302526 A1
(43) Pub. Date: Oct. 22, 2015

(54) PROVIDING A GUI AGGREGATING ATTRIBUTES OF A SURETY BOND APPLICATION

(71) Applicant: Colonial Surety Company

(72) Inventor: Wayne Nunziata, Montvale, NJ (US)

(73) Assignee: Colonial Surety Company

(21) Appl. No.: 14/254,641

(22) Filed: Apr. 16, 2014

(51) Int. Cl. G06Q 40/08

(52) U.S. Cl. CPC G06Q 40/08; G06Q 40/06

(57) ABSTRACT

A method for aggregating attributes of a surety bond in a remote computer bond processing system includes providing a graphical user interface (GUI) displaying menu items corresponding to surety bond attributes. A user request is received to obtain information related to the surety bond attributes via the menu items provided by the GUI. The requested information, related to the one or more surety bond attributes, is generated. The generated information is displayed by the GUI, in response to the received user request.

### FIELD OF THE INVENTION

The present invention generally relates to bonds, including insurance bonds, and, more particularly, to providing a Graphical User Interface (GUI) aggregating attributes of a surety bond application.

### BACKGROUND OF THE INVENTION

By the term surety bond is generally meant a bond issued by an insurance or other company as surety on behalf of a principal whereby the surety legally binds itself to an obligee for an amount of money guaranteed to the obligee for the faithful performance of a contract or other act of the principal. The bonds can include bid bonds, contract, court and subdivision bonds, performance bonds, customs bonds, notary bonds, liquor license bonds, license and permit bonds, small business administration bonds, bail bonds, supersedeas bonds or other bonds required in litigation, etc.

When a contractor, builder or supplier etc. wishes to bid on a construction project or submit a bid in connection with a governmental purchase of equipment or supplies the entity seeking bid typically requires that for a bidder to be considered for the job a bid bond must be submitted with the bid. Many municipalities have their own bid form and others use a format approved of by the American Institute of Architects. In the typical bid bond the principal is the entity who is submitting the bid. The surety is typically insurance or bonding company who pursuant to the bond is “held and firmly bound” to the entity seeking the bid for a predetermined sum, usually some percentage of the bid amount. In the event the bid is accepted the bond becomes effective and protects the entity awarding the contract by assuring the entity of faithful performance of the contract as well as prompt payment of labor and materials furnished in performing the contract. In addition, the bond protects the bid seeking entity from the failure of the winning bidder from ultimately entering into the contract that is being awarded by paying the difference between the winning bid and the amount that the entity would have to pay to another party to complete the project because of the default.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

The embodiments of the present invention are directed to improved methods, apparatus and system for aggregating and presenting attributes of surety bonds, including but not limited to bid bonds, contract, court and subdivision bonds, performance bonds, customs bonds, notary bonds, liquor license bonds, license and permit bonds, small business administration bonds, bail bonds, supersedeas bonds or other bonds required in litigation, etc. The embodiments of the present invention also have applicability in the field of insurance and other businesses including but not limited to binding certificates of insurance and policy endorsements.

In accordance with a purpose of the illustrated embodiments, in one aspect, a computer-implemented method for aggregating attributes of a surety bond in a remote computer bond processing system is provided. The remote computer bond processing system provides a graphical user interface (GUI) comprising menu items corresponding to surety bond attributes. The remote computer bond processing system receives a user request to obtain information related to one or more surety bond attributes via the menu items provided by the GUI. The remote computer bond processing system generates the requested information related to the requested one or more surety bond attributes. The GUI displays the generated information in response to the received user request.

In another aspect, a computer system for aggregating attributes of a surety bond comprises one or more processors, one or more computer-readable storage devices, and a plurality of program instructions stored on at least one of the one or more storage devices for execution by at least one of the one or more processors. The plurality of program instructions includes program instructions to provide a GUI comprising menu items corresponding to one or more surety bond attribute. The plurality of program instructions further includes program instructions to receive a user request to obtain information related to at least one of the surety bond attributes via the menu items. The plurality of program instructions further includes program instructions to generate said requested information related to the surety bond attributes. The plurality of program instructions further includes program instructions to display the generated information in response to the received user request.

### BRIEF DESCRIPTION OF THE DRAWINGS

The accompanying appendices and/or drawings illustrate various non-limiting, examples, inventive aspects in accordance with the present disclosure:

FIG. 1 illustrates an example communication network in accordance with an illustrated embodiment;

FIG. 2 is a block diagram of an exemplary system that may be used to provide pertinent information related to a plurality of surety bond attributes in accordance with an exemplary embodiment of the present invention;

FIGS. 3-11 depict various screen shots of embodiments for a surety bond application attribute aggregation process performed by the system of FIG. 2 in accordance with certain illustrated embodiments of the present invention;

FIG. 12 is a flowchart of operational steps of the bond manager module of FIG. 2 in accordance with an exemplary embodiment of the present invention; and

FIG. 13 illustrates a typical computing system that may be employed to implement some or all processing functionality in accordance with an exemplary embodiment of the present invention.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

As used herein, the term “user” refers to individuals associated with principal entities that have an online account with a financial institution, such as a surety company.

As indicated above, embodiments of the present invention include a method, system, and computer program product that can be used to aggregate and present attributes of surety bonds, including but not limited to bid bonds, contract, court and subdivision bonds, performance bonds, customs bonds, notary bonds, liquor license bonds, license and permit bonds, small business administration bonds, bail bonds, supersedeas bonds or other bonds required in litigation, etc. For example, when a contractor, builder or supplier (principal entity) wishes to bid on a construction project or submit a bid in connection with a governmental purchase of equipment or supplies the entity seeking bid typically requires that for a bidder to be considered for the job a bid bond must be submitted with the bid. In order to obtain a bond, a principal entity typically submits a bond request (application) to a surety company. The surety is typically insurance or bonding company who pursuant to the bond is “held and firmly bound” to the entity seeking the bid for a predetermined sum, usually some percentage of the bid amount. For certain bond requests where the amount of the bond request is low the agent may have the authority to issue a bond without approval from the surety company. For other requests, before the principal entity can obtain a surety bond, they undergo a rigorous prequalification process, called underwriting, to determine whether they are capable of performing a given contract. Among other areas addressed during the underwriting process with a surety company are the following: principal entity's financial status/balance sheet and income statement, bank and credit information, etc. These factors addressed during the underwriting process are referred to herein as attributes of a surety bond application. Since surety companies typically spend a great deal of time and expense in the underwriting process to qualify a principal entity before issuing a surety bond at least some principal entities might be interested in reviewing pertinent information related to various surety bond attributes that may be used by the surety company's underwriting process. These principal entities may use this information to make informed business decisions that could improve their company's financial profile. Various embodiments of the present invention provide a system configured to aggregate attributes of a surety bond application and to provide pertinent information in response to a received user's request.

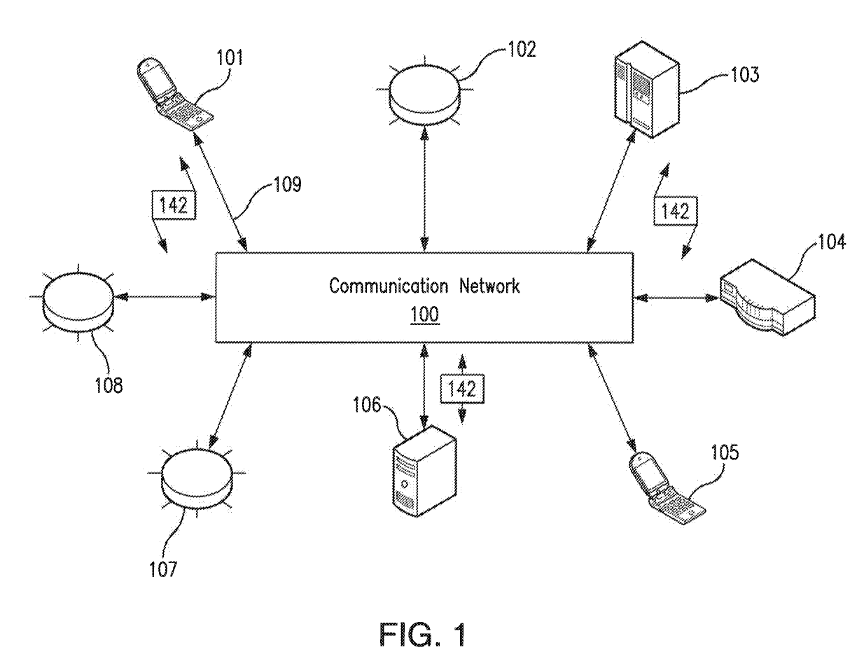

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

An exemplary communication network 100 depicted in FIG. 1 illustratively comprises nodes/devices 101-108 (e.g., sensors 102, bond processing system 103, smart phone devices 101, 105, computing devices 106, routers 107, switches 108 and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

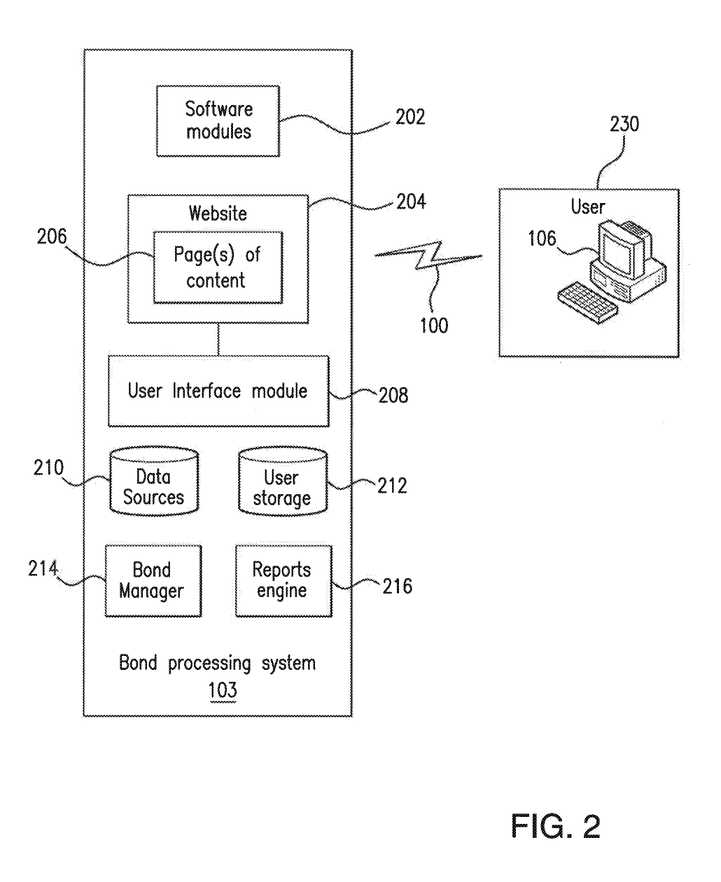

FIG. 2 is a block diagram of an exemplary system that may be used to provide pertinent information related to a plurality of surety bond attributes in accordance with an exemplary embodiment of the present invention. A bond processing system 103, associated with or otherwise maintained by a financial services institution such as a surety company or an insurance company, may include a bond manager module 214 that may be used to aggregate and present surety bond related information to a user 230. The user 230 may communicate with the bond processing system 103 using a computing device 106. The bond manager 214 may obtain and validate users' identifying information prior to granting access to their online account. The bond manager 214 may retrieve user's information from storage, such as user storage 212, and may use the information in aggregating and presenting surety bond attributes that relate to one or more user's surety bond bids. A reports engine 216 may be operatively interconnected with the bond manager 214 and may be configured to generate various reports, such as financial reports and charts illustrative of principal entity's financial trends and health. The reports engine 216 may receive information from the bond manager 214 and from user storage 212, for example. Note that according to some embodiments, the supplemental user information (i.e., credit scores) might be received from one or more data source 210 associated with a third party service (e.g., a credit rating institution).

User storage 212 may contain information pertaining to users who have accounts or products hosted by the bond processing system 103, for example. User storage 212 may contain information directed to users, such as account owner's name and identifying information, account information, user's bid results, etc., for example. In addition, user storage 212 may include data (e.g., principal entity's financial information) that may be used by the bond processing system 103 for underwriting purposes.

Aggregated information directed to various bond attributes may be provided via a website 204 to the user computing device 106 associated with the user 230. In an alternative embodiment of the present invention, instead of hosting the website 204, the bond processing system 103 may comprise a conventional application server hosting a proprietary online service accessible only by a private network. In any event, the bond processing system 103 may have appropriate security mechanisms in place to prevent unauthorized third parties from intercepting the user's information.

The user 230 may provide data to the bond processing system 103 via the user computing device 106. Although in FIG. 2 the computing device 106 is illustrated in the form of a desktop computer, in various embodiments of the present invention the user computing device 106 may be a handheld computing device, such as a smartphone, laptop, tablet computer, or any other suitable device.

In an embodiment of the present invention, a user interface module 208 may receive content from the reports engine 216 or the bond manager 214 and format one or more pages of content 206 as a unified graphical presentation that may be provided to the user computing device 106. The page(s) of content 206 may be directed to aforementioned reports and/or other surety bond attributes-related information and may be provided to the user computing device 106 via the website 204 associated with the bond processing system 103.

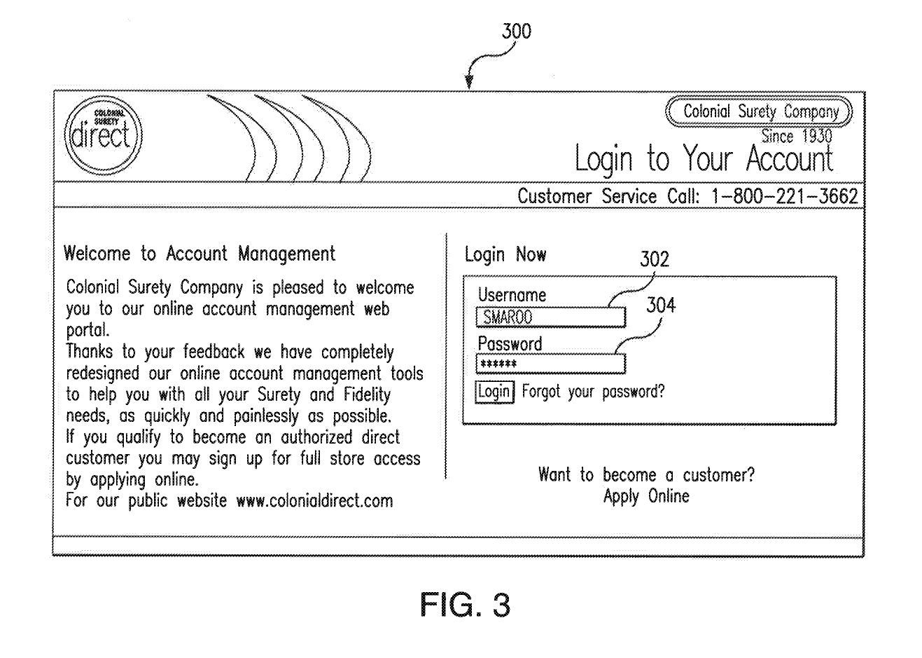

When the user 230 accesses the website 204, using a web browser on the user computing device 106, he/she may be presented with profile information such as principal entity's company profile information and various financial information via the page(s) of content 206. The information may be displayed in one or more web pages, for example. FIGS. 3-11, as discussed below, depict various screen shots of these web pages, according to embodiments of the present invention. The user 230 may enter identifying information into the presented web pages via a web browser on the user computing device 106.

In an embodiment of the present invention, the bond processing system 103 may be implemented as a web server. The bond processing system 103, through the use of any suitable interactive web technology, may provide an interactive experience to the user 230 through which access to his/her online account can be accomplished. Any technology that provides interactivity through a web browser is considered to be within the scope of the present invention and may include, without limitation, Hyper-Text Mark-up Language (HTML), Dynamic HTML (DHTML), JavaScript and Ajax.

In an embodiment, the institution may be a financial services institution (e.g., such as a surety company, an insurance company, or any other entity issuing surety bonds) having a financial services website. On the website 204, the user 230 may be presented with aggregated information related to a plurality of surety bond attributes.

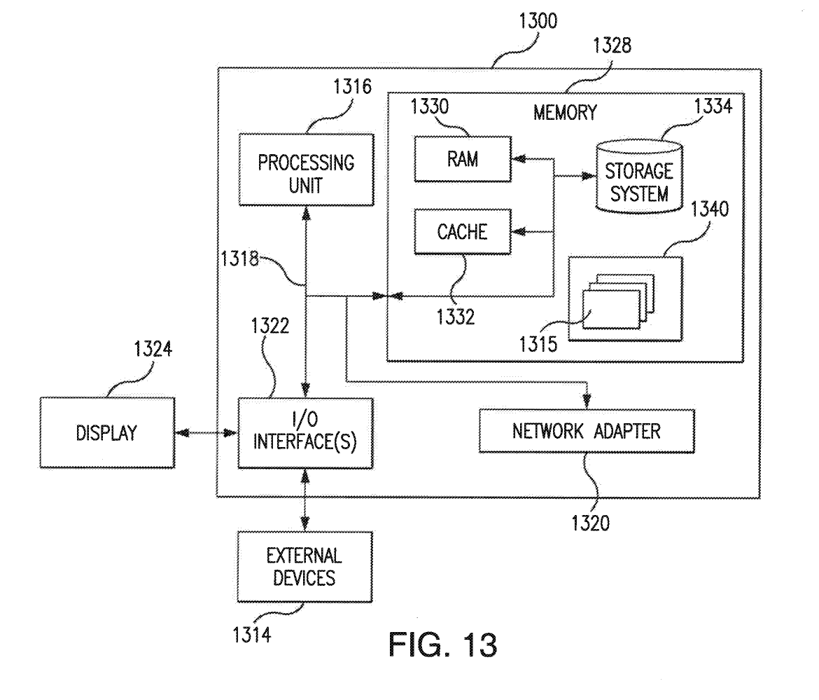

In an embodiment of the present invention, the bond processing system 103 may comprise one or more additional software modules 202. The software modules 202 may be used in the performance of the techniques and operations described herein and may be operatively coupled to the bond manager 214 and reports engine 216 modules. Example software modules may include, without limitations, modules for sending and receiving information between the bond processing system 103 and the user 230, requesting and retrieving information from user storage 212, and generating web pages described herein. While specific functionality is described herein as occurring with respect to specific modules, the functionality may likewise be performed by more, fewer, or other modules. The functionality may be distributed among more than one module. An example computing device and its components are described in more detail with respect to FIG. 13.

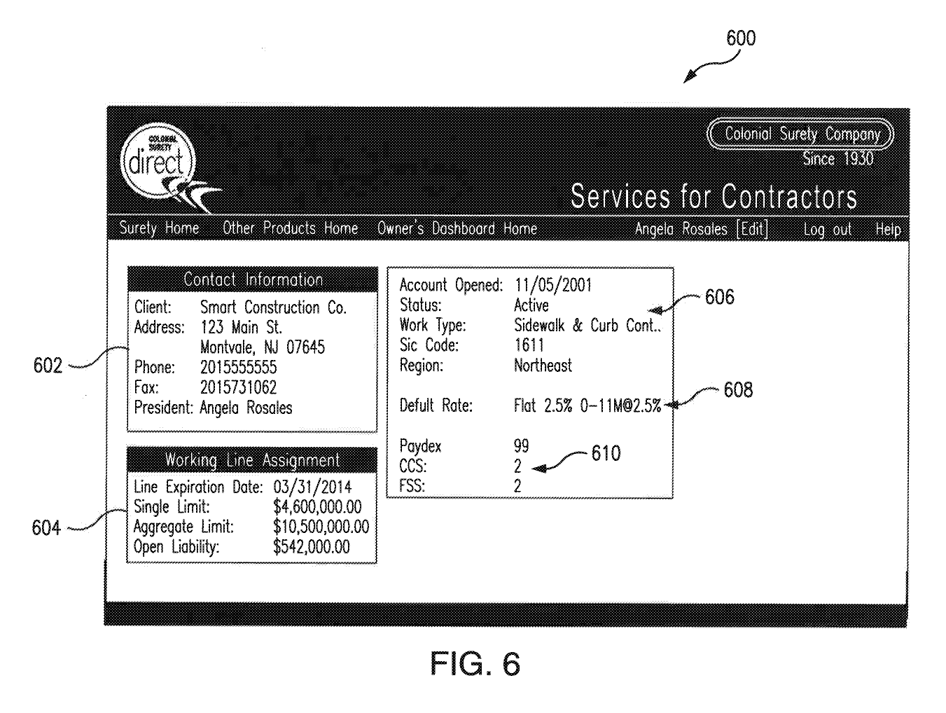

With reference now to FIGS. 3-11, illustrated are various screen shots of embodiments for aggregating attributes of a surety bond application as integrated with the above described bond processing system 103. In particular, FIGS. 6-11 depict resultant screen shots illustrating a particular surety bond attribute used during the underwriting process as performed and executed by the bond processing system 103 of FIG. 2.

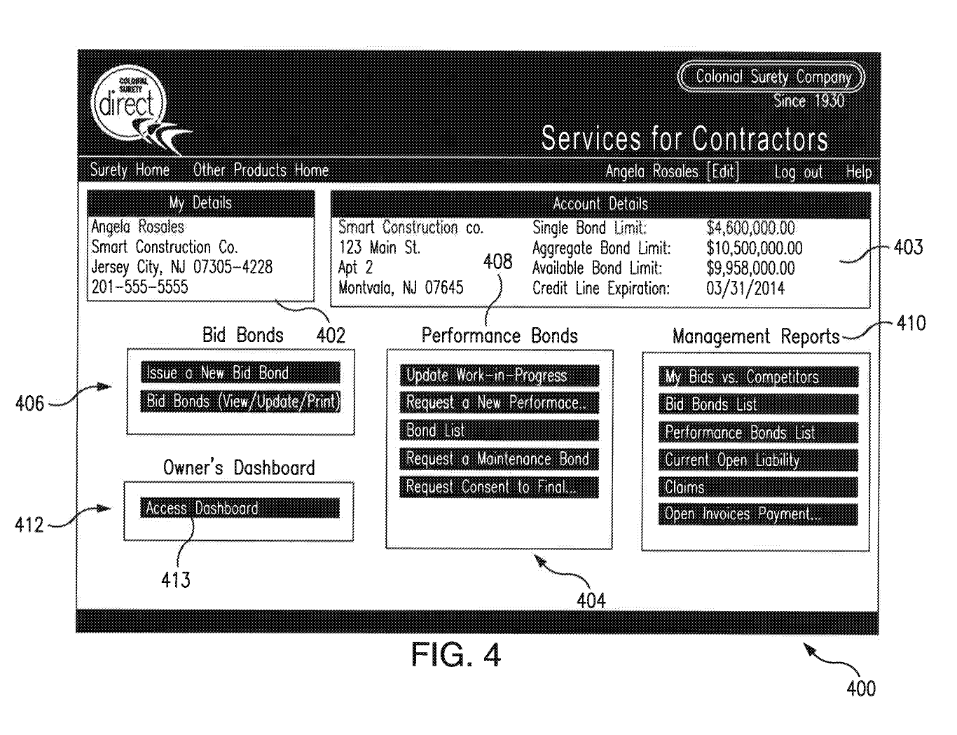

FIG. 3 depicts a welcome screen 300, which can be presented to a user 230 via website 204. According to an embodiment of the present invention, the welcome screen 300 may contain fields for user's identifying (logon) information such as, for example, username 302 and password 304. The user 230 is able to log in to the bond processing system 130 and access his/her account if his/her username and password exist in storage, such as user storage 212, of the bond processing system 103. FIG. 4 depicts a home screen 400, which displays the user's 230 profile 402—namely the profile of Angela Rosales. In addition, the home screen 400 also displays relevant account details 403 specific to user's company (i.e., principal entity). According to an embodiment of the present invention, the home screen 400 also provides menus 404 for further navigation options. These menus 404 include “Bid Bonds” 406, “Performance Bonds” 408, “Management Reports” 410 and “Owner's Dashboard” 412. The “Owner's Dashboard” menu option 412 includes “Access Dashboard” button 413, which enables the user 230 to obtain various information related to attributes of submitted or approved surety bond applications/requests.

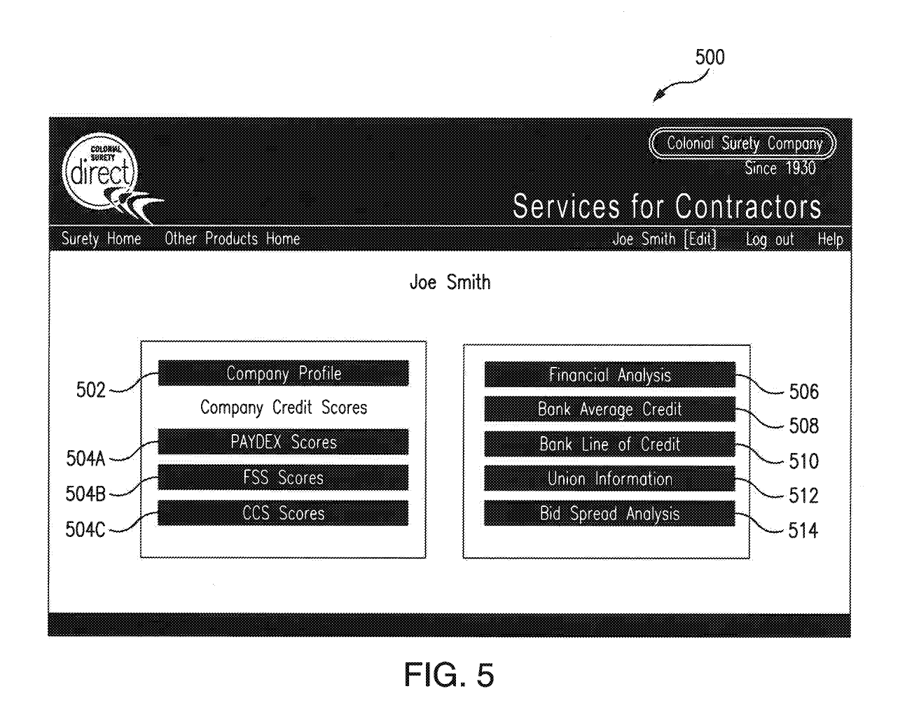

FIG. 5 depicts a subsequent screen 500 (e.g., dashboard home screen) containing further navigation options which may be presented to the user 230 by the bond processing system 103 (via user interface 208, for example) in response to user 230 clicking on “Access Dashboard” button 413. Each of the navigation options 502-514 corresponds to a specific surety bond attribute. According to an embodiment of the present invention, the menu presented on the dashboard home screen 500 may include the following buttons: “Company Profile” 502, one or more buttons associated with company's credit scores (i.e., “PAYDEX Scores” 504A, “FSS Scores” 504B and “CCS Scores” 504C), “Financial Analysis” 506, “Bank Average Credit” 508, “Bank Line of Credit” 510, “Union Information” 512 and “Bid Spread Analysis” 514. It is noted that dashboard home screen 500 may be personalized by the bond processing system 103 and may only present navigation options associated with relevant surety bond attributes (e.g., attributes used by the financial institution to evaluate user's company).

FIG. 6 depicts an exemplary company profile screen 600, which may be displayed when user clicks on “Company Profile” button 502 on the dashboard home screen 500 of FIG. 5. Information presented on the company profile screen 600 provides a quick overview of the user's company's current financial status. According to an embodiment of the present invention, the company profile screen 600 includes company's contact information 602 and working line of credit information 604. In addition, the company profile screen 600 also provides information related to open liability 606, default rate 608 and credit scores 610. The bond processing system 103 may use credit scores to assess the company's financial health and to help predict the likelihood the company may experience financial stress in the next 12 months, for example.

The credit scores utilized by the bond processing system 103 may include Dunn and Bradstreet (D&B) paydex score, Commercial Credit Score (CCS) and Financial Stress Score (FSS). Paydex scores are primarily derived by determining the promptness with which businesses pay their suppliers and creditors. Paydex scores are standardized to range between values of 0-100, wherein values between 0-49 represent a high risk and values 80-100 denote a low risk score. In other words, a value of 100 is representative of a company that submits all payments on time or before they become due and a paydex score of 80 can be a “very good” score and identify that a particular business for which the score is derived is one that has a very low risk of defaulting on its debt obligations. The CSS predicts the likelihood that an entity will pay its bills in a severely delinquent manner, e.g. +90 days past term, over the next 12 months. The CCS uses statistical probabilities to classify risk based on a full spectrum of business information, including payment trends, company financials, industry position, company size and age, and public filings. The CSS scores are standardized to range between values of 1-5 (low to high risk). The FSS predicts an entity's potential for failure. It predicts the likelihood that an entity will obtain legal relief from creditors or cease operations without paying all creditors in full over the next 12 months. The financial stress score uses a full range of information, including financial rations, payment trends, public filings, demographic data, and more. The FSS scores also range between values of 1-5 (low to high risk). It is noted that the bond processing system 103 may periodically (e.g., quarterly) receive the credit scores described above from one or more credit rating institutions. Alternatively, the bond processing system 103 may be integrated with one or more data sources 210 (shown in FIG. 2), which may be associated with the credit rating institutions.

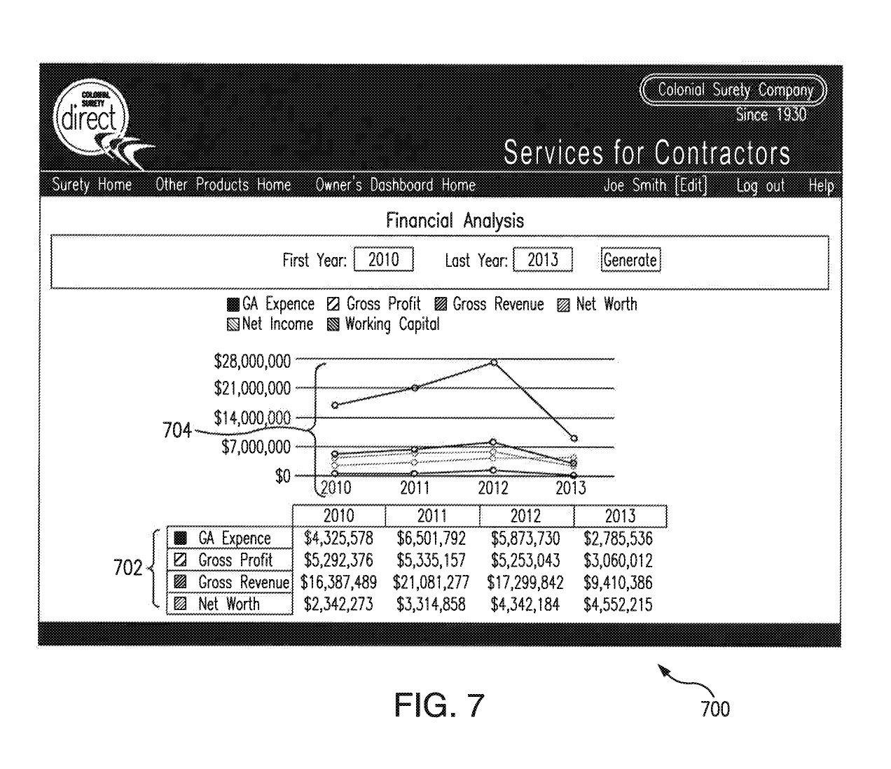

FIG. 7 depicts an exemplary financial analysis screen 700, which may be displayed when user clicks on “Financial Analysis” button 506 on the dashboard home screen 500 of FIG. 5. According to an embodiment of the present invention, the financial analysis screen 700 may contain a report generated by the reports engine 216 based on a specific range of relevant financial information. The generated report may include, for example, a plurality of line graphs 704 representing the entity's overall financial stability derived by evaluating a plurality of financial factors 702. These factors may include, without limitation, expenses, profit, income, revenue and net worth. The bond processing system 103 may use the plurality of graphs 704 depicted in FIG. 7 to adjust principal entity's line of credit. In other words, as the financial strength of a particular entity fluctuates, this fluctuation may affect their line of credit respectively.

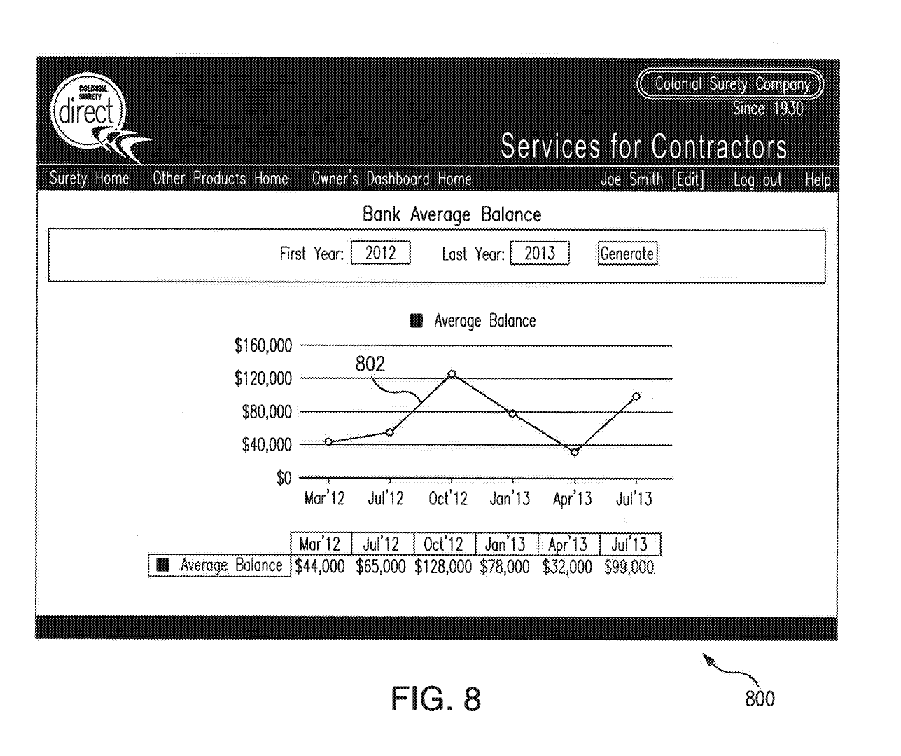

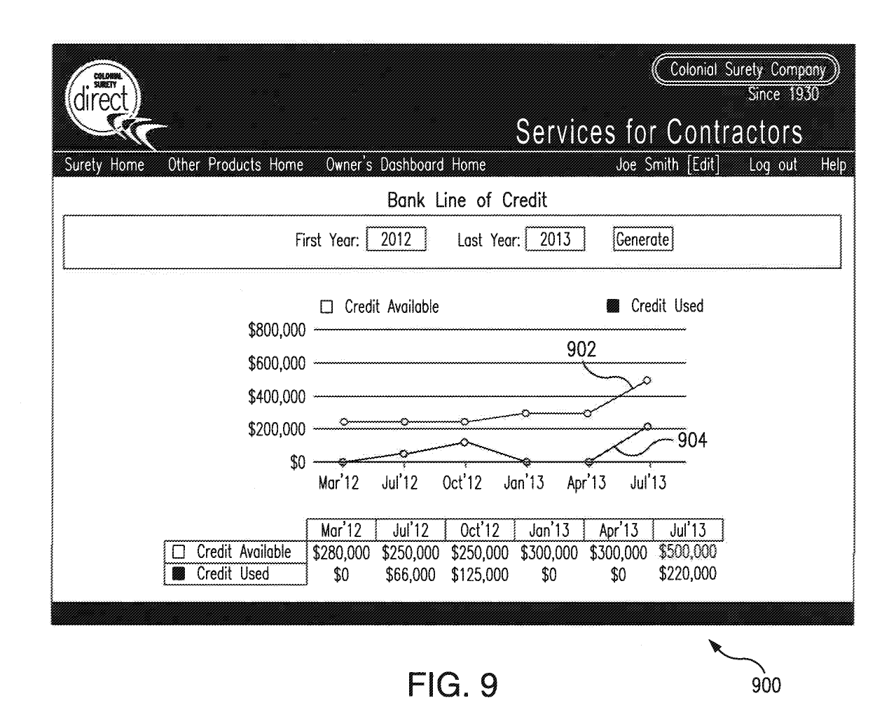

FIG. 8 depicts an exemplary bank average balance screen 800, which may be displayed when user clicks on “Bank Average Credit” button 508 on the dashboard home screen 500 of FIG. 5. According to an embodiment of the present invention, the bank average balance screen 800 may contain a line chart 802 report indicative of the average bank balance trends. FIG. 9 depicts an exemplary bank line of credit screen 900, which may be displayed when user clicks on “Bank Line of Credit” button 510 on the dashboard home screen 500 of FIG. 5. According to an embodiment of the present invention, the bank line of credit screen 900 may contain a report showing how much credit is being used versus what is available. The report shown in FIG. 9 includes two line charts. First line chart 902 shows available credit, while the second chart 904 depicts used credit. The reports illustrated in FIGS. 8 and 9 may be ran by the bond processing system 103 quarterly in order to evaluate principal entity's ability to complete projects.

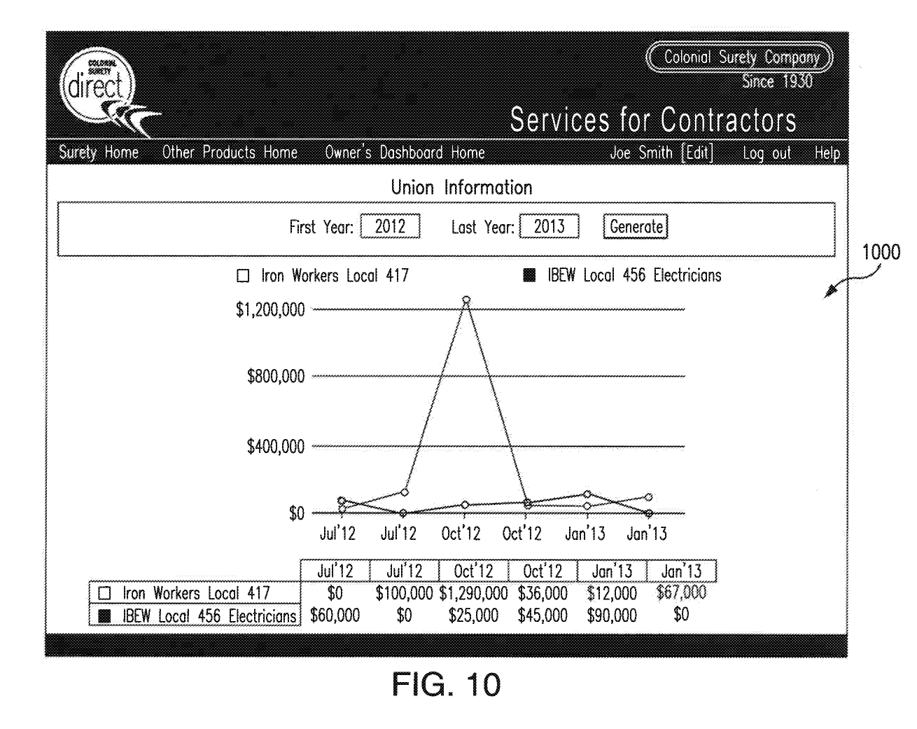

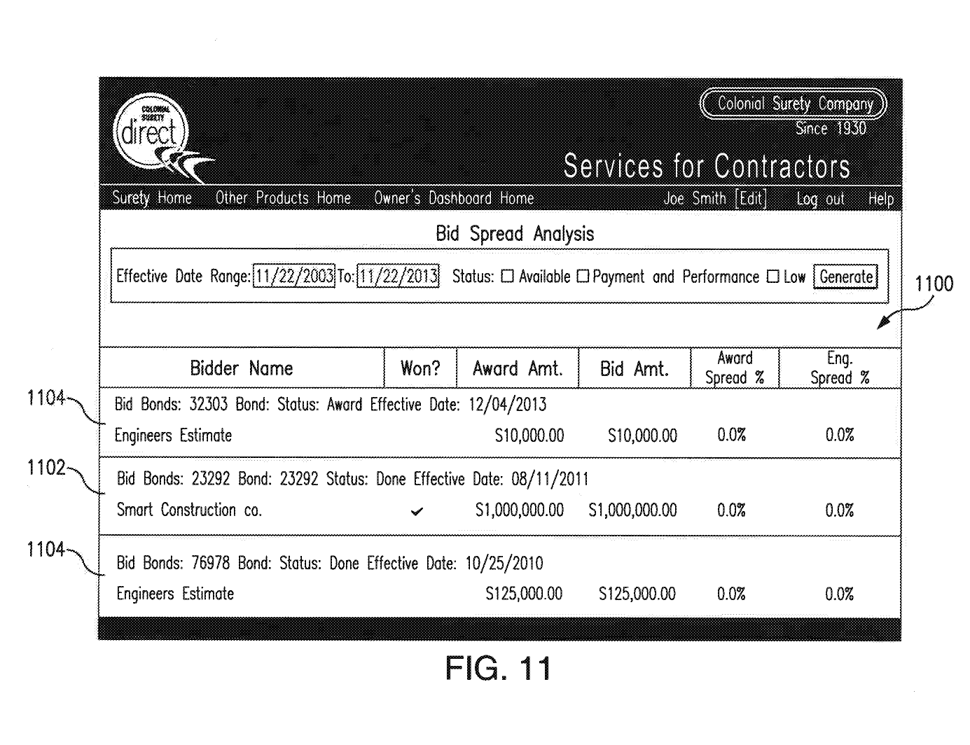

According to an embodiment of the present invention, the underwriting process utilized by the bond processing system 103 may include monitoring principal company's union activity. FIG. 10 depicts an exemplary union information screen 1000, which may be displayed in response to user clicking on “Union Information” button 512 on the dashboard home screen 500 of FIG. 5. Typically, little or no union activity may be an indicator of a financial stress. Accordingly, union information may be included as one of the surety bond attributes. In addition to union information, the bid processing system 103 may evaluate bond bid information. FIG. 11 shows a bid spread analysis screen 1100, which may be displayed in response to user clicking on “Bid Spread Analysis” button 514 on the dashboard home screen 500 of FIG. 5. The bid spread analysis report shown in FIG. 11 displays awarded bidding history and those bids converted into performance bonds. In other words, this report shows the spread (percentage) between the bidders. This report gives users an opportunity to compare their winning bid 1102 with the other bidders 1104.

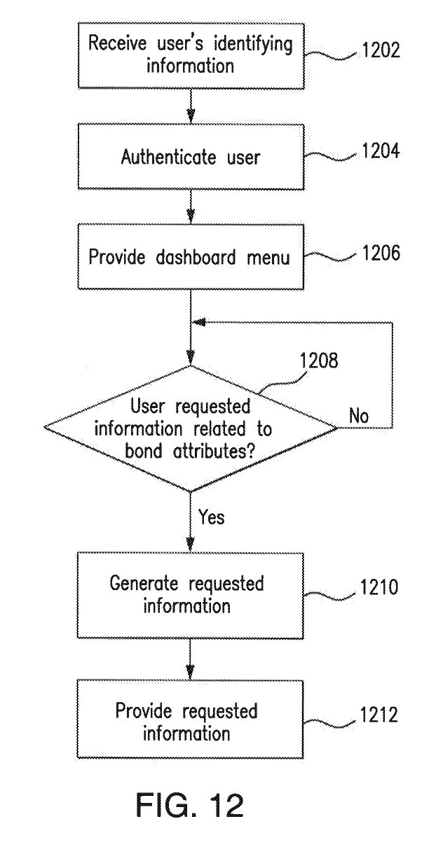

FIG. 12 is a flowchart of operational steps of the bond manager module 214 of FIG. 2 in accordance with exemplary embodiments of the present invention. Before turning to description of FIG. 12, it is noted that the flow diagram shown therein is described, by way of example, with reference to components shown in FIGS. 1-11, although these operational steps may be carried out in any system and are not limited to the scenario shown in the aforementioned figures. Additionally, the flow diagram in FIG. 12 shows example in which operational steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step. In some embodiments, one or more additional steps may be included.

At 1202, the bond manager 214 may receive user's identifying information, such as a user ID associated with his/her online account. According to an embodiment of the present invention, the user 230 may enter his/her username using corresponding fields 302 and 304 on the welcome screen 300 provided, for example, by the user interface module 208, which in turn may pass the identifying information to the bond manager 214 via the request received at 1202. This passing of the identifying information may be performed in a secure manner, such as by encrypting the identifying information. Although the welcome screen 300 shown in FIG. 3 depicts a combination of username 302 and password 304 fields, this identifying information can take a variety of different forms including, without limitation, a fingerprint, a particular passphrase, a digital certificate, and so forth.

At 1204, the bond manager 214 may process the received request to authenticate a particular user. In an embodiment of the present invention, the bond manager 214 may receive this identifying information and compare the received information to information previously stored, for example, in user storage 212. If the received and previously stored information match (e.g., are the same), then the bond manager 214 may search information pertaining to users who have accounts hosted by the bond processing system 103 to determine whether the identified user is a current account holder and may retrieve various information associated with his/her account, for example. If the received and previously stored information do not match (e.g., are not the same), then the user attempting to login is not authenticated and the bond manager 214 may send an appropriate error message back to the user interface module 232 or another software module 202.

As indicated above, in an embodiment of the present invention, once the user is authenticated the user interface module 208 may present the home screen 400 shown in FIG. 4 having a plurality of navigation options 404. If the user 230 selects to review information related to surety bond attributes, he/she may click on the “Access Dashboard” button 413. In response to user's request, at 1206, the bond manager 214 may aggregate all attributes of the corresponding surety bond and may cooperate with the user interface module 232 to display the dashboard home screen 500 shown in FIG. 5.

At 1208, the bond manager 214 may wait until the user selects one of the presented options. If the user makes a selection by pressing one of the buttons 502-514 (step 1208, yes branch), in response, at 1210, the bond manager 214 may generate requested information. For example, if the user 230 presses the “Union Information” button 512, the bond manager 214 preferably loads the union information report 1000. Similarly, if the user 230 presses the “Financial Analysis” button 506, the bond manager 214 preferably generates, in cooperation with the report engine, the financial analysis report 700 shown in FIG. 7. Next, at 1212, the bond manager 214 may provide the generated report to the user interface module 232, which in turn may display a corresponding screen, such as union information screen 1000 or financial analysis screen 700, for example.

In summary, advantageously, the “owner's dashboard” feature of the bond processing system 103 enables users to review all information related to their surety bonds in an easy-to-read format within their online account. The provided information allows users to get an overview of their company's financial stability from an underwriting perspective. The provided information may include, but is not limited to, principal entity's (users' company's) credit scores, banking trends, line of credit usage, and the overall financial analysis.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 13 is a schematic block diagram of an example network computing device 1300 (e.g., bond processing system 103) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 1300 is intended to represent any type of computer system capable of carrying out the teachings of various embodiments of the present invention. Device 1300 is only one example of a suitable system and is not intended to suggest any limitation as to the scope of use or functionality of embodiments of the invention described herein. Regardless, computing device 1300 is capable of being implemented and/or performing any of the functionality set forth herein.

Computing device 1300 is operational with numerous other general purpose or special purpose computing system environments or configurations. Examples of well-known computing systems, environments, and/or configurations that may be suitable for use with computing device 1300 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 1300 may be described in the general context of computer system-executable instructions, such as program modules, being executed by a computer system. Generally, program modules may include routines, programs, objects, components, logic, data structures, and so on that perform particular tasks or implement particular abstract data types. Computing device 1300 may be practiced in distributed data processing environments where tasks are performed by remote processing devices that are linked through a communications network. In a distributed data processing environment, program modules may be located in both local and remote computer system storage media including memory storage devices.

Device 1300 is shown in FIG. 13 in the form of a general-purpose computing device. The components of device 1300 may include, but are not limited to, one or more processors or processing units 1316, a system memory 1328, and a bus 1318 that couples various system components including system memory 1328 to processor 1316.

Bus 1318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 1300 typically includes a variety of computer system readable media. Such media may be any available media that is accessible by device 1300, and it includes both volatile and non-volatile media, removable and non-removable media.

System memory 1328 can include computer system readable media in the form of volatile memory, such as random access memory (RAM) 1330 and/or cache memory 1332. Computing device 1300 may further include other removable/non-removable, volatile/non-volatile computer system storage media. By way of example only, storage system 1334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1318 by one or more data media interfaces. As will be further depicted and described below, memory 1328 may include at least one program product having a set (e.g., at least one) of program modules that are configured to carry out the functions of embodiments of the invention.

Program/utility 1340, having a set (at least one) of program modules 1315, such as bond manager 214 and reports engine 216 described above, may be stored in memory 1328 by way of example, and not limitation, as well as an operating system, one or more application programs, other program modules, and program data. Each of the operating system, one or more application programs, other program modules, and program data or some combination thereof, may include an implementation of a networking environment. Program modules 1315 generally carry out the functions and/or methodologies of embodiments of the invention as described herein.

Device 1300 may also communicate with one or more external devices 1314 such as a keyboard, a pointing device, a display 1324, etc.; one or more devices that enable a user to interact with computing device 1300; and/or any devices (e.g., network card, modem, etc.) that enable computing device 1300 to communicate with one or more other computing devices. Such communication can occur via Input/Output (I/O) interfaces 1322. Still yet, device 1300 can communicate with one or more networks such as a local area network (LAN), a general wide area network (WAN), and/or a public network (e.g., the Internet) via network adapter 1320. As depicted, network adapter 1320 communicates with the other components of computing device 1300 via bus 1318. It should be understood that although not shown, other hardware and/or software components could be used in conjunction with device 1300. Examples, include, but are not limited to: microcode, device drivers, redundant processing units, external disk drive arrays, RAID systems, tape drives, and data archival storage systems, etc.

FIG. 13 is intended to provide a brief, general description of an illustrative and/or suitable exemplary environment in which embodiments of the above described present invention may be implemented. FIG. 13 is exemplary of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer-implemented method for aggregating attributes of a surety bond in a remote computer bond processing system, the method comprising the steps of:
providing, by the remote computer bond processing system, a graphical user interface (GUI) comprising one or more menu items corresponding to one or more surety bond attributes;
receiving, by the remote computer bond processing system, a user request to obtain information related to at least one of the one or more surety bond attributes via at least one of the one or more menu items provided by the GUI;
generating, by the remote computer bond processing system, said requested information related to the one or more surety bond attributes; and
displaying, by the GUI, said generated information in response to the received user request.

2. The computer-implemented method of claim 1, further comprising authenticating a user by the remote computer bond processing system before providing access to said GUI.

3. The computer-implemented method of claim 1, wherein said surety bond attributes comprise at least one of the following attributes: principal entity's profile, one or more credit scores, financial report representative of principal entity's financial stability, bank average balance chart, bank line of credit report, union information related to the principal entity, bid spread analysis report.

4. The computer-implemented method of claim 3, wherein the one or more credit scores comprise at least one of paydex score, commercial credit score, and financial stress score.

5. The computer-implemented method of claim 3, wherein said financial report includes information related to expenses, profit, income, revenue and net worth of said principal entity.

6. The computer-implemented method of claim 3, wherein said bank average balance chart is a trend indicative chart.

7. The computer-implemented method of claim 3, wherein said bank line of credit report includes information related to bank credit used by said principal entity and bank credit available to said principal entity.

8. The computer-implemented method of claim 3, wherein said bid spread analysis report includes bidding history information related to said surety bond.

9. A computer program product for aggregating attributes of a surety bond in a remote computer bond processing system, the computer program product comprising:
one or more computer-readable storage devices and a plurality of program instructions stored on at least one of the one or more computer-readable storage devices, the plurality of program instructions comprising:
program instructions to provide a graphical user interface (GUI) comprising one or more menu items corresponding to one or more surety bond attributes;
program instructions to receive a user request to obtain information related to at least one of the one or more surety bond attributes via at least one of the one or more menu items;
program instructions to generate said requested information related to the one or more surety bond attributes; and
program instructions to display said generated information in response to the received user request.

10. The computer program product of claim 9, further comprising program instructions to authenticate a user before providing access to said GUI.

11. The computer program product of claim 9, wherein said surety bond attributes comprise at least one of the following attributes: principal entity's profile, one or more credit scores, financial report representative of principal entity's financial stability, bank average balance chart, bank line of credit report, union information related to the principal entity, bid spread analysis report.

12. The computer program product of claim 11, wherein the one or more credit scores comprise at least one of paydex score, commercial credit score, and financial stress score.

13. The computer program product of claim 11, wherein said financial report includes information related to expenses, profit, income, revenue and net worth of said principal entity.

14. The computer program product of claim 11, wherein said bank average balance chart is a trend indicative chart.

15. The computer program product of claim 11, wherein said bank line of credit report includes information related to bank credit used by said principal entity and bank credit available to said principal entity.

16. A computer system for aggregating attributes of a surety bond, the computer system comprising one or more processors, one or more computer-readable storage devices, and a plurality of program instructions stored on at least one of the one or more storage devices for execution by at least one of the one or more processors, the plurality of program instructions comprising:
program instructions to provide a graphical user interface (GUI) comprising one or more menu items corresponding to one or more surety bond attributes;
program instructions to receive a user request to obtain information related to at least one of the one or more surety bond attributes via at least one of the one or more menu items;
program instructions to generate said requested information related to the one or more surety bond attributes; and
program instructions to display said generated information in response to the received user request.

17. The computer system of claim 16, further comprising program instructions to authenticate a user before providing access to said GUI.

18. The computer system of claim 16, wherein said surety bond attributes comprise at least one of the following attributes: principal entity's profile, one or more credit scores, financial report representative of principal entity's financial stability, bank average balance chart, bank line of credit report, union information related to the principal entity, bid spread analysis report.

19. The computer system of claim 18, wherein the one or more credit scores comprise at least one of paydex score, commercial credit score, and financial stress score.

20. The computer system of claim 18, wherein said financial report includes information related to expenses, profit, income, revenue and net worth of said principal entity.
